(19) United States
(12) Patent Application Publication
(10) Pub. No.: US 2007/0218290 A1
(43) Pub. Date: Sep. 20, 2007

(54) Method for Doping Material and Doped Material

(75) Inventors: Markku Rajala, Vantaa (FI); Pekka Soininen, Helsinki (FI); Lauri Niinisto, Vantaa (FI); Matti Putkonen, Espoo (FI); Joe Pimenoff, Helsinki (FI); Jani Paivasaari, Espoo (FI)

Correspondence Address: OLIFF & BERRIDGE, PLC, P.O. BOX 19928, ALEXANDRIA, VA, 22320, US

(73) Assignee: Beneq Oy, Vantaa (FI)

(21) Appl. No.: 11/597,358

(22) PCT Filed: Jun. 23, 2005
(86) PCT No.: PCT/FI05/50234

§ 371 Date: Jan. 6, 2007

(30) Foreign Application Priority Data
Jun. 24, 2004 (FI) 20040877
Dec. 17, 2004 (FI) 20045490
Apr. 12, 2005 (FI) 20055166

(51) Int. Cl. C03C 17/09; C03B 25/02

(52) U.S. Cl. 428/411.1; 118/722; 427/401

(57) ABSTRACT

The invention relates to a method for doping material, the method being characterized by depositing at least one dopant deposition layer or a part thereof on the surface of the material and/or on a surface of a part or parts thereof with the atom layer deposition (ALD) method, and further processing the material coated with a dopant in such a manner that the original structure of the dopant layer is changed to obtain new properties for the doped material. The material to be doped is preferably glass, ceramic, polymer, metal, or a composite material made thereof, and the further processing of the material coated with the dopant is a mechanical, chemical, radiation, or heat treatment, whereby the aim is to change the refraction index, absorbing power, electrical and/or heat conductivity, colour, or mechanical or chemical durability of the doped material.

### OBJECT OF THE INVENTION

The invention relates to a method for doping material according to the preamble of claim 1 and to a doped material according to the preamble of claim 34 and to an apparatus according to the preamble of claim 71.

### BACKGROUND OF THE INVENTION

Many problems relate to the doping of materials, especially when the amount of the dopant is significantly small in comparison with the amount of the matrix material. If the dopant amount is under 1%, under 1%o or even under 1 ppm of the amount of the matrix material, it is not possible to achieve homogenous doping with conventional methods. On the other hand, problems with homogenous doping may occur even when the amount of the material to be doped was 1-10% or even 10% of the amount of the matrix material. The problem may then be that homogenous doping takes an unreasonably long time. Non-homogenous doping causes problems when the material is used, because the properties of the material may vary greatly and uncontrollably between different parts of a component made from the material.

Doping can for instance be used when making materials with improved physical properties. The doping of materials can also be used when creating completely new properties for a material. Examples of such properties are electrical conductivity, dielectricity, strength, toughness, and solubility. It is also known that in many applications, a controlled distribution of the dopant in the matrix material further improves these properties. This is especially pronounced when small amounts need to be doped very exactly and when several simultaneous dopants are used. Therefore, in the field of materials technology, there is a significant need to achieve a novel, simple and advantageous method of doping materials in a controlled manner. Controlled distribution can refer to homogenous distribution, for instance, but it can also refer to any desired distribution of a dopant in a material.

In many applications, new properties are provided for a material by coating the material with a dopant. The coating may provide both chemical and physical durability. Coating does, however, have several problems related to the ability of the material being coated and the dopant to bind to each other. Coating does not create a new composition, but the coating and carrier remain as their own layers. In addition, the elastic modulus usually differs from that of the basic material. The elastic modulus of ceramic coatings, for instance, is often higher than that of the basic material. Deformation generated under load thus leads to a higher stress in a weak coating in comparison with the basic material. It can be said that the coating carries the load. This, then, easily leads to the breaking and cracking of the coating. By doping the coating as part of the surface material, it is possible to combine the properties of the coating and basic material without the breakage described above.

Doping can also be performed prior to the melting or sintering of the basic material. An example of this is the manufacture of hard metals by mixing metals and carbides together in powder form. This is typically done by grinding in a mill. The powder mixture is then further processed by compressing it into shape and sintering it into its final shape. Doping performed in this powder metallurgical manner can also be utilized in the manufacture of construction ceramics, supra conductors and other corresponding products. Then, the problem is, however, that the material is contaminated by the mill, grinding pellets and/or grinding liquid. In addition, it is difficult to evenly dope small dopant amounts, and grinding in a mill may destroy the structure of the material.

One special field in material doping is the manufacture of optical fibres that comprises 1) the formation of a porous glass blank, during which the properties of the optical fibre to be drawn from the blank are defined depending on the process parameters, 2) the removal of impurities from the porous glass blank, 3) the sintering of the porous glass blank into a solid glass blank and/or a partially solid glass blank, and finally 4) drawing the glass blank into an optical fibre. Optionally, it is also possible to add glass on the sintered glass blank to make a larger fibre blank.

Doping glass materials and polymer, metal, and ceramic material and their composite materials with various dopants can be performed for instance by melting the material and adding the dopant into the melt. A problem with this type of arrangement is that the melts of these materials are often very viscous, which means that a homogenous mixing of the dopants require a high mixing efficiency. High mixing efficiency generates high cutting forces that may cause the shearing of the material, especially when using polymer materials. The original properties of the material then change irreversibly and the end result may be a material weak in mechanical durability, for instance. Mixing also causes contamination.

A doped porous glass material is used for instance in making optical waveguides, such as optical fibres and optical plane waveguides. An optical waveguide refers to an element used in the transfer of optical power. Fibre blanks are used in making optical fibres. There are several methods for manufacturing the fibre blanks, such as CVD (Chemical Vapour Deposition), OVD (Outside Vapour Deposition), VAD (Vapour Axial Deposition), MCVD (Modified Chemical Vapour Deposition), PCVD (Plasma Activated Chemical Vapour Deposition), DND (Direct Nanoparticle Deposition), and sol gel method.

The CVD, OVD, VAD, and MCVD methods are based on using initial materials having a high vapour pressure at room temperature in the deposition step. In the above methods, liquid initial materials are vaporized into a carrier gas, which may also be one of the gases in the reaction. Initial material vapours produced by different liquid and gas sources are mixed into an as exact mixed vapour as possible that is transferred to the reaction zone, and the vaporous raw materials react with an oxygen compound or one containing oxygen, forming oxides. The formed oxide particles deposit due to agglomeration and sintering together, and end up on a collecting surface on which a porous glass layer is formed of the produced glass particles. This porous glass layer can further be sintered into solid glass. Initial materials used in the above methods are for instance the main raw material in quartz glass, silicon tetra-chloride SiCl₄, the initial material of GeO₂ that increases the refractive index, germanium tetrachloride GeCl₄, and the initial material for P₂O₅ that decreases the viscosity of glass and facilitates sintering, phosphoroxytrichloride POCl₃.

A problem with the CVD, OVD, VAD, and MCVD methods described above is that they cannot easily be used in making optical fibres doped with rare earth metals. Rare earth metals do not have practical compounds with high enough vapour pressure at room temperature. This is why a method called the solution doping method has been developed for the manufacture of optical fibres doped with rare earth metals (RE fibres), in which an undoped fibre blank deposited from basic materials only is dipped into a solution containing dopants before the fibre blank is sintered.

Another known method is to use hot wells in which a solid initial material is heated to achieve a sufficient vapour pressure. The problem then is, however, doping the heated initial material vapour into other initial material vapours before the reaction zone without the initial materials reacting prematurely. In addition, the mixture ratios of the initial materials need to be kept exactly right during the process on the entire deposition surface area so that the properties of the emerging film remain uniform.

It is also known to make optical fibre blanks with the sol gel method. In the sol gel method, the initial materials are generally alkoxides or alkoxide salts of metals. The initial material is hydrolyzed in a solvent into which the initial material polymerizes forming the sol. As the solvent is evaporated from the sol, it gelates into a solid material. Finally, when the gel is heated at high temperature, the rest of the solvent and other organic matter are removed, and the gel crystallizes into its final form. The purity achieved with this method is usually not sufficient for optical fibres.

Generally speaking, a dopant can be doped on the surface of solid material particles or porous materials by using various solution methods in which the material is dipped into a solution containing the dopant. A reasonably even layer of dopant is then obtained on the surface of the material. With this method, it is, however, not possible to obtain a sufficiently homogenous and exact dopant distribution on the surface of the material. The properties of fibres made using the solution method vary in individual fibre blanks and between fibre blanks, which means that the reproducibility of the method is poor. This is due to the fact that the manufacture is dependent on several different factors, such as liquid penetration into the surface of the porous material, salt attachment on the surface of the porous material, gas penetration into the material, salt reactions, doping, etc. Managing all these reactions is difficult or even impossible. Poor reproducibility has an unfavourable effect on yield, which means that the manufacturing costs also increase.

A method called direct nanoparticle deposition (DND) has been developed for manufacturing doped optical fibres and for dyeing glass. In comparison with the solution doping method, this method has the advantage that it is possible to feed liquid raw materials into the reactor used in this method, whereby the glass particles dope in a flame reactor. This way the doped glass particles produce a glass blank whose quality is more even than that produced by solution doping. Collecting nanoparticles is, however, difficult, because the particles follow the movements of the gas flows. It is also not possible to dope porous blanks deposited by other blank manufacturing methods.

### BRIEF DESCRIPTION OF THE INVENTION

It is thus an object of the invention to develop a method in which the above-mentioned problems are solved and/or their effects reduced. In particular, an object of the invention is to provide a novel, simple and advantageous method for doping materials. In addition, an object of the invention is to provide a method with good reproducibility, whereby the quality of the doped materials is uniform regardless of the production lot. A further object of the invention is to provide a doped material having properties of as uniform quality and exactly controlled properties as possible. The object of the invention is achieved by the method according to the characterizing part of claim 1, which is characterized by depositing at least one dopant deposition layer or part of a dopant deposition layer on the surface of the material being doped and/or on the surface of a part or parts thereof with an atom layer deposition (ALD) method. The object of the invention is further achieved with the doped material according to the characterizing part of claim 34, which is characterized in that on the surface of the doped material and/or on the surface of a part or parts thereof, a dopant layer or a part of a dopant layer is deposited with the ALD method. The object of the invention is also achieved with the apparatus according to the characterizing part of claim 71, which is characterized in that the apparatus comprises means for the ALD method for providing at least one dopant deposition layer or a part of a dopant deposition layer on the surface of a material being doped and/or on the surface of a part or parts thereof with the ALD method.

Preferred embodiments of the invention are disclosed in the dependent claims.

It is an advantage of the invention that the dopant layers can be deposited on all surfaces of the matrix material, even on the inner surfaces of pores in such a manner that the layer thickness of the dopant can be exactly controlled and, if necessary, it is substantially equal on all surface of the matrix material. Further, an advantage of the invention is that doping can be performed in a controlled manner, with a good material efficiency, and, if necessary, even in high concentrations.

The invention is based on the idea that the ALD (Atomic Layer Deposition) method is utilized in the method to enable a homogenous doping of a dopant on the surface of a matrix material and/or on the surface of a part or parts thereof. The ALD method is based on deposition controlled by the surface, in which the initial materials are led on the surface of the matrix material one at a time, at different times and separated from each other. A sufficient amount of the initial material is brought to the surface to use up the available bond points of the surface. After each initial material pulse, the matrix material is flushed with an inert gas so as to remove excess initial material vapour to prevent deposition in gas phase. A chemically adsorbed monolayer of the reaction product of one initial material then remains on the surface. This layer reacts with the next initial material and forms a specific partial monolayer of the desired material. After a sufficiently full reaction, any excess of this second initial material is flushed with inert gas, and thus the reaction is based on cyclic saturated surface reactions, i.e. the surface controls the depositing. In addition, the surface is chemically bound to the matrix (chemisorption). In practice, this means that the film is deposited equally on all surfaces, even on the inner surfaces of pores. In doping, this means an extremely even distribution. The thickness of the desired material layer can be exactly defined by repeating the cycle as necessary. However, it should be noted that the cycle could also be left incomplete, for instance using half of a cycle, in which case only half of the cycle is run and only half of a deposition layer is doped in the material. The part of the cycle can be a part of any one cycle. In doping, this means an extremely precise “digital” control of the dopant content. By changing the initial materials during the process, it is possible to create different overlapping films and/or film structures doped in different ways. Correspondingly, it is for instance possible to utilize only the first initial material pulse to produce sufficient doping. In this patent application, the ALD method refers to any conventional ALD method and/or an application and/or modification of the method known to a person skilled in the art. A dopant layer made with the method or a part thereof can also be referred to as dopant deposition layer.

Technologically, the ALD method, which is also known as the ALCVD method, can be considered to belong to the CVD (Chemical Vapour Deposition) techniques. Thus, it utilizes for instance an elevated temperature, pressure control, gas sources, liquid sources, solid sources, and gas washers. The same technologies are also utilized in MCVD preform manufacturing devices, for instance, but in ALD and MCVD, they are utilized in differing ways. The most essential difference in comparison with the conventional CVD methods is that, in these conventional methods, the initial materials are mixed together before they reach the reaction zone in which they then react with each other. The homogeneity of the mixture and its even distribution on different sides of the surface being deposited is crucial to the structure and thickness of the film being made. This can be compared with spray-painting and the evenness problems related thereto. Differing from the conventional CVD methods, in the ALD method deposition is based on successive chemical reactions controlled by the surface, in which case the thickness of the film is controlled by depositing a correct number of dopant deposition layers. The general advantage of the ALD method in comparison with the conventional CVD methods can be contrasted with the advantages of the digital technology in comparison with the analogue technology. In addition, ALD makes it possible to use extremely reactive initial materials, which is not possible in the conventional CVD method. An example of initial materials of this type is the use of TMA (trimethylene aluminum) and water as initial materials in the ALD process. These initial materials react strongly with each other already at room temperature, which means that their use in conventional CVD would be impossible. An advantage in using TMA is that it produces a high-quality Al₂O₃ film with good efficiency, and the initial materials need not necessarily be heated, which needs to be done even with vacuum reactors when using an alternative Al initial material, such as aluminum chloride (typically 160° C.).

The use of the method is not merely limited to the use of a full reaction cycle, but it can also be utilized in cases where the supply of just a second initial material suffices to produce a suitable set of additives. The chemisorpted layer is then used in further processing.

With the method described above, it is possible to provide a doped material of the present invention, on the surface or partial surface of which a dopant layer is deposited with the atom layer deposition method. The properties of such a material doped with the ALD method can very accurately be defined by means of the initial materials and control parameters used in the method. It is then possible to produce doped materials with properties that are considerably better in their application area than those achieved with the conventional techniques.

The present invention further relates to an application area of the method described above for doping glass material, which can for instance be a porous optical fibre, fibre blank, plane waveguide, or some other glass material or blank used in making the above with the method. The dopant layers can then be deposited on all surfaces of the porous glass material, i.e. even inside the pores, in such a manner that a desired dopant layer is formed on all surfaces of the porous glass material, and a doped glass material of the invention is produced.

The dopant can be one or more agents selected from agents that comprise a rare earth metal, such as erbium, ytterbium, neodymium, and cerium, an agent of the borium group, such as borium and aluminum, an agent of the carbon group, such as germanium, tin, and silicon, an agent of the nitrogen group, such as phosphor, an agent of the fluorine group, such as fluorine, and/or silver and/or any other agent suitable for doping a porous glass material. The agent may be in element or compound form.

Such a porous glass material to be doped, for instance a glass blank, can be made with any conventional method, such as CVD (Chemical Vapour Deposition), OVD (Outside Vapour Deposition), VAD (Vapour Axial Deposition), MCVD (Modified Chemical Vapour Deposition), PCVD (Plasma Activated Chemical Vapour Deposition), DND (Direct Nanoparticle Deposition), and sol gel method, or any other similar method. By means of these methods, for instance an undoped porous glass material deposited of mere basic materials can be stored and then as necessary doped according to the present invention and further treated in conventional steps into an optical fibre, for instance.

When a porous glass material is being made, it is important to make sure that the porous glass material comprises reactive groups on the surface of the porous glass material and/or on the surface of a part or parts thereof. Reactive groups can be OH groups, OR groups (alkoxide groups), SH groups, NH₁₋₄ groups, and/or any other groups reactive to conventional dopants, to which the dopants can attach. In one application, the reactive groups are hydroxyl groups with which the dopants react during the deposition of a dopant layer.

By controlling the number of reactive groups on the surface of a porous glass material, it is possible to control the amount of dopant on the surface of the porous glass material.

Hydroxyl groups are formed in the glass material in the presence of hydrogen, whereby both Si—H and Si—OH groups are formed. The reactive groups, such as hydroxyl groups, can be added on the surface of the porous glass material by processing the glass material with hydrogen, especially with a gas and/or liquid comprising hydrogen and/or a hydrogen compound, at a high temperature. Reactive groups can also be added by processing the glass material by radiation, for instance electromagnetically or with γ rays, and after and/or before this, processing it for example with hydrogen, especially with a gas and/or liquid comprising hydrogen and/or a hydrogen compound. The radiated area can also be processed with any other similar agent to form reactive groups on the surface of the porous glass material and/or on the surface of a part or parts thereof.

When doping a porous glass material with the ALD method, the reactive groups, for instance hydroxyl groups, are efficiently removed from the porous glass material, such as a glass blank, as the dopant reacts with the reactive groups. If necessary, the doped porous glass material can be cleaned after doping by removing any possibly remaining reactive groups and possible other impurities. An example of this is reducing the OH content from an optical fibre blank. This reduces the signal attenuation caused by a water peak due to the OH groups.

In one application, the porous glass material is quartz glass, i.e. silicon oxide (SiO₂). The glass material may also be any other glassforming oxide, such as B₂O₃, GeO₂, and P₄O₁₀. The porous glass material may also be phosphor glass, fluoride glass, sulphide glass, and/or any other conventional glass material.

In one application, the porous glass material is partially or completely doped with one or more agents including germanium, phosphor, fluoride, borium, tin, titan, and/or any other similar agent.

A required specific surface area of the porous glass material is provided by controlling the particle size when the porous glass material is made. When the mass/volume flow to be deposited is high, for instance 1 to 100 g/min, the glass particles become large, for instance submicron- or micron-size, before attaching to the collecting surface. The pores between the particles are then in the size range of micrometres. When the mass/volume flow is smaller, 1 to 100-nm size particles can be deposited on the collecting surface, and the size of the pores between them is smaller. The particle size can also be controlled in any other suitable manner by adjusting the process parameters during the depositing of the porous glass material. In one application, the specific surface area of the porous glass material is preferably >1 m²/g, more preferably >10 m²/g, and most preferably >100 m²/g.

When the porous glass material is deposited according the present invention, it can be further processed in conventional steps to obtain the desired final product, such as an optical waveguide. After the glass material is doped, it can be sintered into a solid, non-porous glass material, in which case the dopants diffuse into the glass material. Glass material that has been sintered solid can be further processed, for instance drawn into an optical fibre.

The previous method produces doped waveguides, optical fibres, and fibre blanks of the present invention, or glass materials used in making them, or alternatively any doped glass materials.

In one doping application, it is possible to essentially improve the MCVD method in such a manner that doped optical fibres can be made with the method of the invention. This method of the application of the invention can also be applied to improving already existing MCVD equipment and, consequently, economically provide new products for optical fibre manufacturers using the MCVD method. With the method of the invention, doping porous glass material with a required dopant is done very accurately, with an even quality and a better reproducibility than with the known methods. According to this application, before depositing at least one dopant layer on the surface of the porous glass blank being doped and/or on the surface of a part or parts thereof with the ALD method, at least one porous glass material layer is deposited with the MCVD method on the inner surface of a hollow glass blank, such as a glass tube, in substantially the same device in such a manner that at least one part of the hollow glass blank serves as the reactor in the ALD method. In other words, in this application, at least one porous glass material layer is provided with the MCVD method on the inner surface of the hollow glass blank, after which a dopant deposition layer is deposited on the surface of the glass blank or a part thereof with the ALD method in such a manner that the hollow glass blank serves as the reactor in the ALD method. Both the steps of the MCVD method and the steps of the ALD method are performed in essentially the same device, which may be a modified MCVD device, for instance.

The invention provides the advantage that in the method, it is possible to use a porous glass material made with several known alternative methods. This porous glass material can be made for storage for use in the manufacture of optical fibres or other final products as necessary. With the method of the invention, doping a porous glass material with a required dopant is done very accurately, with an even quality and a better reproducibility than with the known methods. The invention further has the advantage that with the ALD method used in depositing the porous glass material, the dopant can be deposited exactly the required amount and the thickness of the dopant layer can be varied in a controlled manner, even to the degree of a partial atom layer, from one glass material to the other.

The invention provides the further advantage that the method permits Sn deposition, which was not possible earlier.

A yet further advantage of the invention is that the exact and adjustable method provides an economically advantageous method that ensures the manufacture of exactly the required type of porous glass material without any loss of material.

### DETAILED DESCRIPTION OF THE INVENTION

The invention relates to a method for doping material, the method comprising depositing at least one dopant deposition layer on the surface of the material and/or on the surface of a part or parts thereof with the atom layer deposition method, and further processing the material coated with the dopant in such a manner that the original structure of the dopant layer is changed to obtain new properties for the doped material.

Earlier, the ALD method has been utilized in manufacturing active surfaces (e.g. catalysts) and thin films (e.g. EL displays). In these methods, a film is deposited on the surface of the material, and the film is hoped to provide the required properties. This way, the dopant provides the material with the required surface chemical properties or the required physical properties of the film deposited on the surface of the material. The structure of the thin film or film combination prepared on the surface of the material with the method of the present invention is changed and/or at least partially destroyed during further processing, whereby its components together with the basic agent form the new compound material. The properties of this material doped during further processing change due to the diffusion, mixing, or reaction of the dopant/agents. The changing property of the doped material may for instance be its refractive index, absorptive ability, electrical and/or thermal conductivity, colour, or mechanical or chemical durability. With it, it is also possible to remove unwanted compounds, such as OH groups.

During further processing, the dopant may diffuse with the material and consequently, a very homogenous doped material is produced.

During further processing, the dopant may diffuse with the material and consequently, a very homogenous doped material is produced. On the other hand, in another embodiment, the dopant dissolves in or mixes partially or entirely with the material being doped during further processing. Doping in the material being doped may be complete, but with diffusion, for instance, the doping can be achieved to a suitable depth of the basic material, such as 1 to 10 μm coatings and photoconductors on the surface of a silicon wafer. It is also possible that during further processing, the dopant remains part of the intermediate phase structure of the material being doped. The desired dopant layer is then deposited on the surface of the particle-like material being doped, after which, during further processing, the particle-like material is sintered into a uniform structure, whereby the particle-like structure remains partly, and between the particles, a binding intermediate phase is formed of the at least partly deposited dopant layer. Such an intermediate phase may also contain other auxiliary agents related to sintering that are not necessarily introduced to the material through the ALD method. The film deposited by means of the ALD method can also be this additive of sintering.

In one embodiment of the invention, the dopant reacts with the material being doped during further processing and forms a new compound that becomes part of the created structure. On the other hand, the material being doped may be a composite material or composition that is not entirely homogenous in its chemical composition. In such a case, a dopant deposited with the ALD method during further processing may react and form different compounds at different points of the material being doped. Correspondingly, an additive deposited with the ALD method can be the one to form the composite phase, in which case the basic agent does not receive the entire additive, but part of the composition forms another type of compound.

Further processing may be mechanical or chemical processing, radiation or heating. Further processing refers for instance to sintering or melting and re-crystallizing the material, in which case individual particles or the porous material becomes a solid structure. In heat processing, the material does not, however, necessarily need to melt, but it is sufficient that the dopant layer is doped or diffused at least partially with the material/s being doped and/or reacts with this or other agents. One example of this type of situation is the use of the dopant as a fluidizer or an intermediate agent when attaching one material to another, such as in a solder joint, biocompatibility, separation as functional groups on the surfaces, or the like.

With the method of the invention, it is also possible to deposit a dopant layer on a specific section of the material surface. This way, the dopant layer is formed at only predefined points of the material. Predefined doped patterns/areas can be formed on the material with a method in which the material is preprocessed for instance by radiating into the material a predefined pattern/area and processing the material in such a manner that reactive groups are formed in or removed from the preprocessed pattern/area. After this preprocessing, the dopant layer can be deposited with the ALD method, and the obtained product can then be further processed to obtain the desired properties for the material.

To obtain a sufficient doping amount, it is not necessary to perform a full ALD cycle with the method of the invention. In other words, instead of a full ALD cycle, only the first initial material is supplied and, after that, flushing is performed. The supply of the second initial material and its extra flushing are left out. This is possible when, during the first round, enough of the compound containing the dopant binds to the reactive groups, in which case forming new reactive groups for the next round and depositing new layers is not necessary. In certain applications, this is beneficial, because the diffusion that takes place during doping is stronger with ions than oxides, for instance. In addition, this may also provide the option of utilizing a different chemistry when forming the intermediate phases. Processing time is also saved, which is significant especially for porous materials in which gas diffusion takes a relatively long time.

In one embodiment of the method, the material to be doped is a porous or particle-like material and its specific surface area is over 1 m²/g, preferably over 10 m²/g, and most preferably over 100 m²/g. The material to be doped may also be a uniform solid or amorphous material. In another embodiment of the invention, the material to be doped is on the surface of a carrier. In such a case, the material to be doped can be brought to the surface of the carrier and/or the surface of a part or parts thereof with the atom layer deposition method.

In the method of the invention, the material to be doped may for instance be glass, ceramic, polymer, metal, or a composite material made thereof. This type of material may comprise reactive groups to which the dopants may bind. The reactive groups are preferably selected from the following: —OH, —OR, —SH, and/or —NH₁₋₄, wherein R is hydrocarbon. In an embodiment of the method of the invention, reactive groups are added to the surface of the material being doped by processing the material by radiation or by allowing the surface to react with a suitable gas or liquid, such as hydrogen, that forms an active group on the surface of the material. A source generating ionizing radiation or non-ionizing radiation can be used in the radiation. In addition to radiation, the number of surface points can be controlled for example by thermal and chemical processing, such as hydrogen processing. The amount of dopant on the surface of the material being doped can then be controlled by adjusting the number of reactive groups in the material being doped.

In the method of the invention, the dopant can be an additive, auxiliary agent, filler, colouring agent, or some other additive of the material to be doped. The dopant may especially be a heat, light or electrically conductive auxiliary agent, reinforcement agent, plasticizer, pigment, or sintering additive.

In the method, the initial materials are brought to the surface of the matrix material one at a time. In the ALD method, after the initial material pulse, a chemisorpted monolayer of a reaction product I of one initial material remains on the surface of the material. This layer reacts with the next initial material and forms a specific partial monolayer of the required dopant. After the initial material pulses, the matrix material is preferably flushed with an inert gas. The thickness of the dopant layer is exactly controlled by repeating the cycle as necessary. Correspondingly, the composition of the dopant can be controlled by changing the number of the pulses of different initial materials relative to each other.

The method of the invention can be utilized in doping glass blanks, i.e. performs, used in manufacturing optical fibres, for instance. An example of this is adding erbium used in reinforcing fibres together with aluminum to an SiO₂ matrix. In this method, the glass blank is made of porous glass powder that is not sintered solid before the ALD process. After this, this preform made up of approximately less than 100 nm glass powder particles is doped with one or more dopants by first depositing on the surfaces of the particles a compound thin film with the ALD method. The following step is sintering, during which the extremely evenly distributed dopants can be made diffuse with the basic material. The method can also be used for other core dopings, such as doping yttrium oxide in fibre structures used in high-power lasers. The thin film formed during the method is thus destroyed and its components form a new compound material together with the basic material. The general physical and chemical properties of this compound material differ from the properties of the basic material and the dopant film. Therefore, the ALD method is not only utilized for the control of surface chemistry or forming a physical film, but it is also utilized in a completely new manner in which a new material with balanced properties is formed with it. The method can also be utilized with other than glass materials, such as metals, ceramics, and plastics.

In the manner described above, the cladding of the glass blank can be doped in a controlled manner with fluorine, for instance, by utilizing the ALD method. This is necessary for instance when the cladding must be smaller in refractive index than the core. Adding fluorine can also be done with other methods, but with ALD it can be done in a controlled manner, in high contents and saving material. Fluorine compounds SiF₄ or SiCl₃F, for instance, can then be used alternately with an oxygen compound and/or chlorine compound.

Correspondingly, the method can be utilized when making optical channels, optical and electric active and passive structures on a silicon wafer by doping or segregation, and in other corresponding applications.

In the method of the invention, the dopant can comprise one or more agents and it can be in element or compound form. For instance, the dopant may comprise a rare earth metal, such as erbium, ytterbium, neodymium, or cerium, an agent of the borium group, such as borium or aluminum, an agent of the carbon group, such as germanium, tin, and silicon, an agent of the nitrogen group, such as phosphor, an agent of the fluorine group, such as fluorine, or silver or any other agent suitable for doping material.

As stated earlier, the material to be doped with the method of the invention may be glass, ceramic, polymer, metal, or a composite material made thereof. Ceramics processable with the method are for instance Al₂O₃, Al₂O₃ SiC whiskers, Al₂O₃—ZrO₂, Al₂TiO₅, AlN, B₄C, BaTiO₃, BN, CaF₂, CaO, forsterite, glass ceramics, HfB₂, HfC, HfO₂, hydroxylapatite, cordierite, LAS (Li/Al silicate), MgO, mullite, NbC, Pb sirconate/titanate, porcelain, Si₃N₄, sialon, SiC, SiO₂, spinel, steatite, TaN, technical glasses, TiB₂, TiC, TiO₂, ThO₂, and ZrO₂, but they may also be any other ceramics. With the method of the invention, it is possible to dope for instance yttrium (Y) in sirconium dioxide (ZrO₂), wherein yttrium serves as the phase stabilization agent, or aluminum oxide (Al₂O₃) in silicon nitride (Si₃N₄), wherein aluminum oxide serves as an auxiliary agent for sintering and later as a component. Silicon nitride based ceramics form a new group of materials suitable for construction purposes. Herein several good properties have been successfully combined, and due to them the materials can be used in demanding applications. In hot-press form Si₃N₄ has one of the highest heat distortion points measured in ceramics. Their heat expansion is small and thermal conductivity relatively high, which makes them suitable for applications with high thermal shocks and high load at the same time. Sialons are a side group made up of Si₃N₄ and Al₂O₃ mixtures combining many of the best properties of each material. With the method of the present invention, these properties can be further improved.

Examples of polymers are natural polymers, such as proteins, polysaccharides, and rubbers, synthetic polymers, such as thermoplastics and thermosetting plastics, and synthetic and natural elastomers. In conventional polymer composites, the fillers are generally distributed at micrometre level. With the method of the invention, it is possible to make the fillers distribute at nanometre level, whereby considerable improvements in the mechanical and other properties of the polymers are possible. Manufacturing polymers doped with nanofillers makes it possible to manufacture novel nanocomposite materials for several different applications.

The metals can be any metals, such as Al, Be, Zr, Sn, Fe, Cr, Ni, Nb, and Co, or their alloys. Doping is the most usual method to provide a metal with the desired properties. The structure of metal is a crystal grating, and when the temperature of metal approaches its melting point, the crystal grating breaks. Dopants can replace the atoms of the basic material in the metal grating, or settle in the gaps between the atoms. Atoms of the same size replace each other and small atoms settle in the interstitial sites. The properties of many alloys can be improved with thermal treatment, whereby even low dopant contents affect strongly the microstructure. In the method of the invention, the dopant can be doped extremely homogenously on the surface of metal and after this, during further processing with heat, for instance, the dopant can be mixed into the microstructure of the metal. An alloy can be formed in three ways: a) an alloy atom settles in its “normal” place in the crystal grating, forming a substitution solution, b) the alloy atom settles in the interstitial site, forming an interstitial solution, or c) the size of the alloy atom is wrong in comparison with the basic atom, and no substitutional or interstitial solution is formed, but new phases, i.e. granules, with the basic metal and alloy in them are formed in the alloy. An example of the use of the method according to the invention in doping metal is doping aluminum oxide (Al₂O₃) into an aluminum matrix.

The material to be doped can also be a material containing silicon or a silicon compound, such as 3-BeO—Al₂O₃-6-SiO₂, ZrSiO₄, Ca₃Al₂Si₃O₁₂, Al₂(OH)₂SiO₄, and NaMgB₃Si₆O₂₇(OH)₄.

The material to be doped can also be a glass material made of any conventional glass-forming oxide, such as SiO₂, B₂O₃, GeO₂, and P₄O₁₀. The glass material to be doped can also be a material doped earlier, for instance a phosphor glass, fluorine glass, sulphide glass, or the like. The glass material may be doped with one or more agents comprising germanium, phosphor, fluorine, borium, tin, titan, and/or any other corresponding agent. Examples of glass materials are K—Ba—Al-phosphate, Ca-metaphosphate, 1-PbO-1,3-P₂O₅, 1-PbO-1,5-SiO₂, 0,8-K₂O-0,2-CaO-2,75-SiO₂, Li₂O-3-B₂O₃, Na₂O-2-B₂O₃, K₂O-2-B₂O₃, Rb₂O-2-B₂O₃, crystal glass, soda glass, and borosilic glass.

A material prepared with the method of the invention can also serve as an intermediate material when a third product or material is made. An example of this is the preparation of a core blank with ALD doping before it is combined with a cladding that may also be doped with ALD. Another example is doping powdered particles and their later mixing with a matrix material.

The method of the invention can further be used when making the cladding and core of a glass blank, a photoconductor, the structures of a silicon wafer, hard metal, surface doping, or a composite material.

In accordance with what is stated above, the present invention relates to doped materials, such as doped glass materials, which are prepared according to different characteristics of the method described above.

The invention further relates to an apparatus for doping material, the apparatus comprising means for an ALD method for providing at least one dopant deposition layer on the surface of the material to be doped and/or on a surface of a part or parts thereof with an atom layer deposition method (ALD method). The apparatus may also comprise means for further processing the material doped with a dopant such that the original structure of the dopant layer changes to obtain new properties for the doped material. The apparatus may further comprise means for an MCVD method so that before the deposition of at least one dopant deposition layer on the surface of a porous glass blank and/or on the surface of a part/parts thereof with the ALD method means, the MCVD method means are used to deposit at least one porous glass material layer on the inner surface of a hollow glass blank, such as a glass tube, substantially in the same device so that at least part of the hollow glass blank serves as the reactor of the ALD method.

The method can also be utilized in making the material easier to process in the next process step. An example of such a procedure is sludge casting, in which good process methods and surface chemical agents suitable for sludge casting (such as for steric stabilization in preparing sludge) have been developed during the years for aluminum oxide. When it is necessary to process silicon nitride, for instance, suitable agents and formula parameters need to be found for it, which is a demanding task. If a thin aluminum oxide layer is deposited on silicon nitride, its surface begins to act like aluminum oxide, and the existing formulas and surface-active agents can again be used. In this case, aluminum oxide is also a desired auxiliary agent for sintering, and its amount and distribution can be provided in a controlled manner in the same process step. Other possibly required auxiliary agents can also be added between it and the basic material without altering the surface properties.

The method can be utilized in dyeing glass bottles internally. In such a case, the surface controlled deposition of the ALD method is utilized in doping the auxiliary agent on the inner surface of a bottle (or a similar shape). In the method, a suitable glass-dyeing compound is deposited on the inside of the bottle. Then, by increasing the temperature, it is diffused into the structure of the inner surface. The result is a beautiful colour visible through the glass surface and resembling deep varnishing. This can be utilized for instance in making perfume bottles or creating a distinctive outlook for a product.

### EXAMPLE 1

### Making an Al₂O₃/Er₂O₃-Doped Glass Blank with the ALD Method

The functionality of the present invention, i.e. the use of the ALD method in doping a porous glass material, was studied by depositing an Al₂₃/Er₂O₃ layer on the surfaces of a porous glass blank used in making optical fibres.

The porous glass blank was made using the previously known sol-gel method. The glass blank can also be made with any other conventional method for manufacturing a porous glass blank. The porous glass blank was a SiO₂ blank.

When making the porous glass blank with the sol-gel method, the glass blank contained over 200 ppm (by weight) of hydroxyl groups. To provide an efficient ALD method, the number of hydroxyl groups was increased further by processing the glass blank with hydrogen after radiation. After the processing, the number of hydroxyl groups was 1000 ppm.

After the glass blank was made, Al₂O₃/Er₂O₃ layers were deposited on the surfaces of the porous glass blank with the ALD method.

For instance, the following initial materials can be used as the initial material for Al₂O₃:

AlX₃, wherein X is F, Cl, Br, or I,

X₃Al, i.e. an organometallic compound, wherein X is H, CH₃, CH₃CH₂, (CH₃)₂CH₂, etc.,

AlX₃, wherein X is a ligand coordinated from oxygen or nitrogen, such as etoxide, isopropoxide, 2,2,6,6-tetramethylheptanedione, acetylacetonate, or N,N-dialkylacetamidenate.

In addition to the above-mentioned, it is also possible to use compounds in which the ligands are combinations of the above.

For instance, the following initial materials can be used as the initial material for erbium:

ErX₃, wherein X is F, Cl, Br, I, or nitrate,

Er(X)₃ or Er(X)₃Z, wherein X is a ligand coordinated through oxygen, for instance one or more of the following: 2,2,6,6-tetramethyloctanedione, 2,2,6,6-tetramethylheptanedione, acetylacetonate, or the like, and Z is for instance tetraglyme, pyridine-N-oxide, 2,2′-bipyridyl, or 1,10-phenantroline, or a corresponding neutral ligand,

X₃Er or X₃ErZ, wherein Z is C₅Z₅ (Z=H or R) or a derivative thereof or a corresponding η¹-, η⁵-, or η⁸-coordinated ligand, and Z is a neutral ligand,

ErX₃, wherein X is a ligand coordinated through nitrogen, for instance alkylsilylamido, or N,N-dialkyacetamidenate.

In deposition, as a second initial material for both aluminum and erbium initial materials, it is possible to use a compound containing oxygen, such as water, hydrogen peroxide, oxygen, ozone, or various metal alkoxides.

This experiment used (CH₃)₃Al and Er(thd)₃ (thd=C₁₁H₂₀O₂) as initial materials. Water and ozone were used as initial oxygen materials. A temperature of 300° C. was used in the depositions. A deposition set was done by changing the pulse ratio between the Er(thd)₃/O₃ and (CH₃)₃Al/H₂O pulses between 1:0 and 0:1.

The deposition with the ALD method comprised two steps. First an Al₂O₃ layer was deposited on the surfaces of the glass blank by using (CH₃)₃Al and H₂O as initial materials, and then an Er₂O₃ layer was deposited on the surfaces of the glass blank by using Er(thd)₃ and O₃ as initial materials. The cycle was continued until a sufficiently thick layer was formed.

The ALD method was found to be an efficient method in making an Al₂O₃/Er₂O₃-doped porous glass blank. The amounts required in a typical Er blank as well as the ratios between the agents being doped were provided with the ALD method by means of low cycle numbers. This way, the process time was short and the costs low.

It was also found that Al₂O₃ doping could be used in increasing the refractive index instead of the expensive GeO₂ doping that is conventionally used to increase the refractive index.

After doping, the remaining OH groups were removed and the porous glass blank sealed, during which the diffusion forces evened the concentration ratio of the surface of the pores and the glass blank and formed at the same time an evenly Al₂O₃-— and Er₂O₃-doped porous blank.

After this, a silicon dioxide cladding was formed around the blank. Finally, the blank and cladding were sintered. The result was a clear fibre blank that was drawn into a fibre.

### EXAMPLE 2

### Making an Al₂O₃/Er₂O₃-Doped Glass Blank with the MCVD and ALD Methods

The use of the ALD/MCVD method of the present invention in doping glass material was studied using a combination of the ALD and MCVD methods. In the study, an Al₂O₃/Er₂O₃ layer was doped on the inner surface of a glass blank used in manufacturing optical fibres at a stage when a porous core part had been deposited on the inner surface of the blank.

The glass blank was made using the previously known MCVD method. In the method, a glass tube made of synthetic quartz glass was fastened to a glass lathe in which the tube was rotated. Silicontetrachloride SiCl₄, phosphoroxychloride POCL₃, and silicontetrafluoride SiF₄ were led inside the tube through a rotating connection from a gas chamber. The tube was heated with a hydrogen-oxygen flame from a quartz glass burner. In the hot spot generated by the hydrogen-oxygen flame, the raw materials reacted and formed quartz glass particles doped with fluorine and phosphor. Due to thermophoresis, these particles flowed in the gas flow direction on the inner surface of the tube and attached thereto. As the hydrogen-oxygen burner also moved in the flow direction, the hot flame sintered the attached particles into a transparent glass layer. After this, the burner was quickly returned to the rotating connection end of the quartz glass tube and a second glass layer was deposited, and so on, until a sufficient number of glass layers were deposited to form the cladding area of the finished fibre.

The harmful gases created in reactions taking place inside the tube were led through a soot box to a gas scrubber.

After this, the gas glows entering the tube were changed so that only silicontetrachloride SiCl₄ was led into the tube. The burner gas flows to the hydrogen-oxygen burner were reduced so that the temperature of the hot spot decreased in such a manner that the formation of siliconoxide glass particles continued, but the glass tube did not heat sufficiently to sinter the porous glass layer. It is apparent to a person skilled in the art that the same can be achieved for instance by moving the hydrogen-oxygen burner so quickly that the tube does not have time go heat up to the temperature required by sintering. During the experiments, it was unexpectedly found that by controlling the feed rate of the material and the rate of travel of the burner, it is possible to control the particle size of the porous layer being deposited, and consequently also the size of the particles, to thus optimize the porous glass layer to be suitable for a later ALD deposition. Enough porous glass layers were deposited that a sufficient amount of the agent was obtained for the core of an optical fibre.

To achieve an efficient ALD method, hydroxyl groups were added to the porous blank by radiating the glass blank and treating it with hydrogen after the radiation. After the process, the number of hydroxyl groups was 1000 ppm.

After making the porous layer, Al₂O₃/Er₂O₃ layers were deposited on the surfaces of the porous glass blank with the ALD method. The method of the invention was characterized in that the quartz glass tube, on the inner surface of which the porous layer was deposited, served as the reactor required in the ALD process. This way, the porous blank did not need to be detached from the glass processing lathe, and the fibre blank that is extremely sensitive to impurities remained clean during the process.

For ALD deposition, the flow of the MCVD gases from the flow system was stopped, and for ALD deposition, the gases were led from the flow system. It is apparent for a person skilled in the art that these flow systems can be separate or integrated. The hydrogen-oxygen burner used in MCVD deposition was moved away in a suitable manner from the vicinity of the tube so that a heating oven could be arranged around the tube to increase the inner temperature of the tube to approximately 300° C.

A sealing element was mounted on the gas scrubber side of the quartz glass tube, through which the negative pressure required for ALD deposition was sucked in. For the sake of clarity, the soot box is not drawn in the figure.

For instance, the following initial materials can be used as the initial material for Al₂O₃:

AlCl₃/H₂O (100 to 660° C.),

AlCl₃/Al(OEt)₃ or Al(OⁱPr)₃ (300, 400° C.),

AlCl₃, Al(OEt)₃, Al(OPr)₃/various alcohols (300 to 500°),

(CH₃)₂AlCl/H₂O (125 to 500° C.),

(CH₃)₃Al/H₂O (80 to 600° C.),

(CH₃)₃Al/H₂O₂ (room temperature to 450° C.),

(CH₃CH₂)₃Al/H₂O (600 to 750° C.),

(CH₃)₃Al/Al(OⁱPr)₃ (300° C.),

(CH₃)₂(C₂H₅)N:AlH₃/O₂ plasma (100 to 125° C.).

For instance, the following initial materials can be used as the initial material for erbium:

ErX₃, wherein X is F, Cl, Br, L or nitrate,

Er(X)₃ or Er(X)₃Z, wherein X is a ligand coordinated through oxygen, for instance one of the following: 2,3,6,6,-tetramethylectanedion, 2,2,6,6-tetramethylheptanedion, or acetyl acetonate, and Z is for instance tetraglyme, pyridine-N-oxide, 2,2′-bipyridyl, or 1,10-phenantroline, or a corresponding neutral ligand,

X₃Er or X₃ErZ, wherein X is C₅Z₅ (Z=H or R), or a derivative thereof, or a corresponding η¹-, η⁵-, or η⁸-coordinated ligand, and Z is a neutral ligand,

ErX₃, wherein X is a ligand coordinated through nitrogen, for instance alkylsilylamino or N,N-dialkylacetamidenate.

In this test, (CH₃)₃Al and Er(thd)₃ (thd=C₁₁H₂₀O₂) were used as initial materials. The oxygen initial materials were water and ozone. A temperature of 300° C. was used in the depositions. The deposition set was done by altering the pulse ratio between the Er(thd)₃/O₃ and (CH₃)₃Al/H₂O pulses between 1:0 to 0:1.

Doping with the ALD method comprised two steps. First, an Al₂O₃ layer was deposited on the surface of the glass blank by using (CH₃)₃Al and H₂O as the initial materials, next, an Er₂)₃ layer was deposited on the surfaces of the glass blank by using Er(thd)₃ and O₃ as the initial materials. The cycle was continued until a sufficiently thick layer was achieved.

The ALD method was found to be an efficient method in the manufacture of an Al1₂O₃/Er₂O₃-doped porous glass blank. The amounts required for a typical Er blank and the ratios of doped materials were obtained with the ALD method by using low cycle numbers. This way, the process time and costs remained low.

In addition, it was noted that Al₂O₃ doping can be used to increase the refractive index instead of the expensive GeO₂ doping used conventionally for this.

After ALD doping, the apparatus was returned to its original setting and the remaining OH groups were removed by chlorine treatment, and after this, the porous glass layers were sintered into transparent glass layers.

Finally, the blank and cladding were collapsed, i.e. the tube blank was heated until the tube collapsed. The result was a clear fibre blank that was drawn into a fibre.

It is apparent to a person skilled in the art that as technology advances, the basic idea of the invention can be implemented in many different ways. The invention and its embodiments are thus not limited to the above examples, but may vary within the scope of the claims.

### EXAMPLE 3

### The ALD Deposition of Example 2

In this experiment performed to test the method of the invention, a special fibre blank, special preform, was doped with aluminum and erbium with the ALD method. In the experiment, 10 rounds of the (1*Er(O3+1*A/H2O) cycle were run with the attached process values, and the following results were obtained:

Initial preform:

| | | |
|---|---|---|
| Porosity: | 58% | |
| Thickness of soot layer | 29 | um |
| Temperature | 300° | C. |
| Pulse time TMA + water + | all á 5 | min |
| ER(thd3) + O3 | | |
| Corresponding flushing times | 5 | min |
| Pressure | 2 | mbar |

| | |
|---|---|
| Obtained concentration | Er/(Er + Al + Si) = 0.038 (mol/mol) |
| | Er/Al = 1.28. |

The concentrations of the special fibre blank obtained in the test are more than sufficient for its application, so even a smaller pulse number achieves the correct doping. The example reveals that the process works for porous materials, and it can be utilized to efficiently produce sufficient doping even at low cycle numbers. The process is also quite rapid in comparison with the impregnation methods used earlier. Depending on the used initial materials and basic materials, other material modifications than doping are also possible.

1-77. (canceled)

78. A method for doping material by depositing at least one dopant deposition layer or a part of a deposition layer on the surface of a material to be doped and/or on the surface of a part or parts thereof with the atom layer deposition method (ALD method), comprising further processing the material doped with a dopant in such a manner that the original structure of the dopant layer is changed or at least partially destroyed whereby its components together with the basic agent form the new compound material.

79. A method as claimed in claim 78, wherein the material to be doped is a uniform solid or amorphous material.

80. A method as claimed in claim 78, wherein the material to be doped is particle-like or porous.

81. A method as claimed in claim 78, wherein the material to be doped is glass, ceramic, polymer, metal, or a composite material made thereof.

82. A method as claimed in claim 81, wherein the glass material is a porous glass material or a glass blank used in manufacturing optical fibres or optical plane waveguides.

83. A method as claimed in claim 81, wherein the porous glass material or glass blank is made using one of the following methods: CVD (Chemical Vapour Deposition), OVD (Outside Vapour Deposition), VAD (Vapour Axial Deposition), MCVD (Modified Chemical Vapour Deposition), PCVD (Plasma Activated Chemical Vapour Deposition), DND (Direct Nanoparticle Deposition), and sol gel method.

84. A method as claimed in claim 81, wherein the porous glass material is quartz glass, phosphor glass, fluoride glass and/or sulphide glass.

85. A method as claimed in claim 81, wherein the porous glass material is partially or entirely doped with one or more materials that comprise germanium, phosphor, fluorine, borium, tin and/or titanium.

86. A method as claimed in claim 81, wherein prior to depositing at least one dopant deposition layer on the surface of the porous glass blank and/or on the surface of a part or parts thereof with the atom layer deposition method (ALD method), at least one porous glass material layer is deposited on the inner surface a hollow glass blank with the MCVD method substantially in the same device in such a manner that at least some part of the hollow glass blank serves as the reactor of the ALD method.

87. A method as claimed in claim 78, wherein the specific surface area of the material to be doped is over 1 m²/g.

88. A method as claimed in claim 78, wherein at least some of the layers are deposited of different dopants.

89. A method as claimed in claim 78, wherein the further processing of the material coated with the dopant is a mechanical, chemical, radiation, or heat treatment.

90. A method as claimed in claim 78, comprising adding reactive groups on the surface of the material being doped by treating the material being doped with radiation, and/or by allowing its surface to react with a suitable gas or liquid that forms active groups on the surface of the material being doped.

91. A method as claimed in claim 90, comprising adjusting the dopant amount on the surface of the material being doped by adjusting the number of reactive groups in the material being doped.

92. A method as claimed in claim 78, wherein the method also comprises flushing the surface of the material being doped with an inert gas between the depositions of the layers with the atom layer deposition method.

93. A method as claimed in claim 78, wherein the material to be doped is on the surface of a carrier.

94. A method as claimed in claim 78, wherein during further processing, the dopant is dissolved, diffused, or mixed partially or entirely with the material being doped.

95. A method as claimed in claim 78, wherein during further processing, the dopant remains as part of the intermediate phase of the material being doped.

96. A method as claimed in claim 78, wherein the material to be doped is a composite material or a composition, and during further processing, the dopant provided with the ALD method reacts and forms different compounds at different points of the material being doped.

97. A method as claimed in claim 78, wherein the properties of the material being doped change due to the diffusion, dissolution, mixing or reaction of the dopant.

98. A method as claimed in claim 78, wherein the new property of the material being doped is a changed refraction index, absorbing power, electrical and/or heat conductivity, colour, or mechanical or chemical durability.

99. A method as claimed in claim 78, wherein the dopant is an additive, auxiliary agent, filler, colouring agent, or composition.

100. A method as claimed in claim 99, wherein the dopant is an auxiliary agent of heat, light or electrical conductivity, reinforcement agent, plasticizer, pigment, or sintering additive.

101. A method as claimed in claim 82, wherein when the material being doped is a porous glass material, it is doped partially or entirely with one or more agents comprising a rare earth metal, an agent of the borium group, an agent of the carbon group, an agent of the nitrogen group, an agent of the fluorine group, and/or silver.

102. A method as claimed in claim 78, wherein it is used in making the cladding of a glass blank, the core of a glass blank, a photoconductor, structures of a silicon wafer, hard metal, surface doping, or composite material.

103. A doped material, wherein it is produced according to claim 78.

104. An apparatus for doping material comprising means for the ALD method to provide at least one dopant deposit layer or a part thereof on the surface of the material being doped and/or on the surface of a part or parts thereof by using the atom layer deposition method (ALD method), wherein the apparatus comprises also comprises means for further processing the material doped with a dopant in such a manner that the original structure of the dopant layer is changed or at least partially destroyed whereby its components together with the basic agent form the new compound material.

105. An apparatus as claimed in claim 104, wherein the apparatus further comprises means for the MCVD method.

106. An apparatus as claimed in claim 105, wherein the means for the MCVD and ALD methods are arranged in such a manner that prior to depositing the at least one dopant deposition layer on the surface of the porous glass blank being doped and/or on the surface of a part or parts thereof with the ALD method means, at least one porous glass material layer is deposited on the inner surface of a hollow glass blank with the MCVD method means.

107. An apparatus as claimed in claim 106, wherein at least some part of the hollow glass blank serves as the reactor in the ALD method.
